(19) United States
(12) Patent Application Publication
(10) Pub. No.: US 2009/0021467 A1
(43) Pub. Date: Jan. 22, 2009

(54) Display Device

(76) Inventor: Yoshihiro GOHARA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/866,204

(22) Filed: Oct. 2, 2007

(30) Foreign Application Priority Data
Oct. 11, 2006 (JP) 2006-277761

(51) Int. Cl. G09G 3/36

(52) U.S. Cl. 345/102

(57) ABSTRACT

[Problem] A non-self-luminous display device is enabled infallibly to alarm a trouble in a display that is inclusive of a power source system.

[Means for Solving the Problem] The display device is provided with a non-self-luminous display 1, an image processor 2 for driving the display based on an image signal and a control signal entered from the outside, a power source circuit 3 for supplying an electric power to the image processor 2, a light source 6 for irradiating the display 1 with light, a light source driver 7 for supplying an electric power to the light source 6 and controlling the brightness of the light source 6, and a monitoring circuit 8 for monitoring the observed value consisting of at least either the value of electric current or the value of voltage of a power source line intervening between the power source circuit 3 and the image processor 2, and is characterized by the monitoring circuit 8 outputting to the light source driver 7 a trouble detection signal indicating occurrence of a trouble when the observed value deviates from a given range and the light source driver 7 admitting the trouble detection signal and varying the light-emitting condition such as the brightness of the light source 6.

### BACKGROUND OF THE INVENTION

1. Field of the Invention

This invention relates to a display device provided with a non-self-luminous display and a light source for irradiating the display with light.

2. Description of the Related Art

The liquid crystal display device that is one kind of non-self-luminous display device has been heretofore used in ordinary electronic instruments such as personal computers, cell phones, and televisions. The range of its applications has been rapidly expanding in consequence of providing higher performance. In recent years, its application has been widely beginning to be applied in fields that demand high reliability, such as gauges and instruments of automobiles, vehicles, aircraft, and marine vehicles.

Incidentally, when the liquid crystal display device causes malfunctions such as vanishing its display partly or fully, the viewer will immediately discover those troubles. This is because the liquid crystal display device itself serves as a display and those troubles are generally appeared on its display screen. Thus, the liquid crystal display device assigns no appreciably high importance to its trouble alarming function. The liquid crystal display devices for use in the existing cell phones and televisions, therefore, are not particularly furnished with an alarming system that notifies the viewers of the occurrence of those troubles.

The troubles occurring in the liquid crystal display devices for use in displays of measuring instruments, however, hinder the safety with respect to the operation of automobiles, vehicles, aircraft, and marine vehicles and, therefore, the viewers must be accurately notified of such troubles. When an image partly or fully vanishes on the display screen, the viewers can easily notice the trouble. When an image is continuously displayed on the screen without being renewed, however, the display screen will reveal no such a trace as indicating the occurrence of a trouble. Thus troubles are hard to be detected based on the idea that correct information was displayed, and the viewers possibly swallow the wrong information.

As a technique for informing the viewers of a trouble in the liquid crystal display device, Japanese Unexamined Patent Application Publication No. 2004-53988, for example, discloses a technique that displays the error history of a fluorescent tube on the on-screen display (OSD). The fluorescent tube is used as the back light on the back of the liquid crystal panel. This technique, however, is directed to showing the trouble in the back light and cannot cope with the trouble in the display system in the liquid crystal device that does not renew the displayed contents.

### SUMMARY OF THE INVENTION

This invention has been proposed in view of the actual condition of the conventional technique and is aimed at providing a display device that is capable of infallibly alarming a trouble in the display system inclusive of a power source system in the non-self-luminous display device.

With a view to solving the problem mentioned above, the display device contemplated by this invention is provided with a non-self-luminous display, an image processor for driving the display based on an image signal and a control signal entered from the outside, a power source circuit for supplying an electric power to the image processor, a light source for irradiating the display with light, a light source driver for supplying an electric power to the light source and controlling the brightness of the light source, and a monitoring circuit for monitoring the observed value consisting of at least either of the value of electric current or the value of voltage of a power source line intervening between the power source circuit and the image processing part, and is characterized by the monitoring circuit outputting to the light source driver a trouble detection signal indicating occurrence of a trouble when the observed value deviates from a given range and the light source driver admitting the trouble detection signal and varying the light-emitting condition of the light source

When an abnormality occurs in the image processor including a display such as a liquid crystal display panel and a driver for driving the display, for example, the value of electric current or the value of voltage are greatly fluctuated in the power source line supplying electric power from the power source circuit to the image processor unlike the duration of a normal operation, the detection of a trouble in the display system is realized by monitoring the value of electric current or the value of voltage.

Meantime, it is necessary that the viewers be informed of the result of detecting troubles. Since the display or the image processor is in trouble, however, the display does not function normally and serve as notification. In the display device configured as described above, therefore, the viewers are successfully notified of the trouble by leading the light source driver to control the light-emitting condition of the light source such as the change of brightness and consequently inducing change of the brightness of the screen. Since the display and the light source are driven separately by different drivers and either of them operates normally even when the other has incurred a trouble, the notification of the trouble is infallibly implemented no matter what mode of trouble the display may have developed.

This invention is capable of providing a display device with high reliability such that the viewers are infallibly and intelligibly alarmed of the occurrence of a trouble in the display by such a simple operation as controlling the brightness of the light source even under the trouble mode rendering difficult discrimination from the situation of normal operation as when the displayed contents on the screen are not renewed, for example.

### BRIEF DESCRIPTION OF THE DRAWINGS

FIG. 1 is a block diagram illustrating one example of the liquid crystal device as one mode of embodying this invention.

### DESCRIPTION OF THE PREFERRED EMBODIMENTS

Now, the display device contemplated by this invention will be explained in detail below by citing, for example, a transmission-type liquid crystal display device while referring to the accompanied drawings.

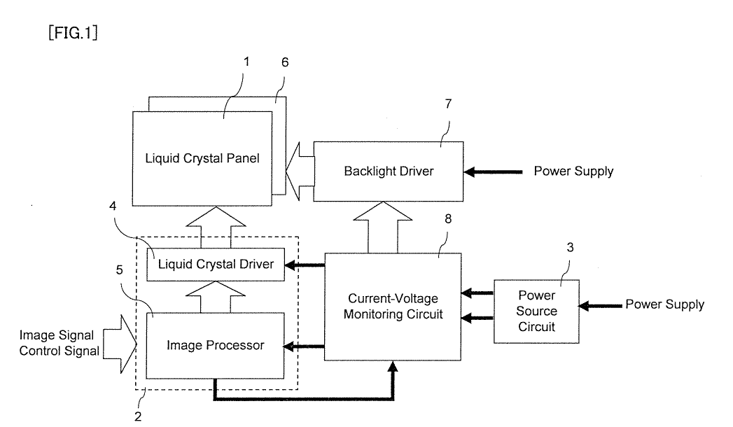

The liquid crystal display device having applied this invention is provided, as illustrated in FIG. 1, with a liquid crystal panel 1 that is a non-self-luminous display. To a liquid crystal panel 1, an image processor 2 for driving the liquid crystal panel 1 based on an image signal and a control signal entered from the outside is connected. The image processor 2 is composed of a liquid crystal driver (the display driver) 4 and an image processing circuit 5 and is operated based on the electric power supplied from a power source circuit 3. The image processing circuit 5 carries out signal processing for converting the image signal entered from the outside into the display data and the timing data of the format capable of being processed by the liquid crystal driver 4 and as well carries out timing control based on the control signal entered from the outside with a view to controlling the liquid crystal driver 4. The liquid crystal driver 4 drives the liquid crystal panel 1 based on the relevant electric power received from the power source circuit 3, the timing data received from the image processing circuit 5, and the display data. The power source circuit 3 is intended to forward the electric power supplied from the outside to the component parts of the display system. For example, it converts the power source voltage supplied from the outside to the pertinent value of voltage and outputs the resultant voltage. That is, during the normal operation of the liquid crystal device, the pertinent electric current and voltage are supplied from the power source circuit 3 via the power source line to the liquid crystal driver 4 and the image processing circuit 5 that jointly constitute the image processor 2.

A backlight (light source) 6 is disposed on the back of the liquid crystal panel 1. The backlight 6 irradiates the liquid crystal panel 1 from behind, converts the image information on the liquid crystal panel 1 into change in optical transmittivity, and consequently accomplishes the display of the image. To the backlight 6, a backlight driver (light source driver) 7 of the method of pulse width modulation (PWM) serving to supply electric power to the backlight 6 is connected. The backlight driver 7 controls the brightness of the backlight 6 and the timing of lighting by transforming the voltage supplied from the outside into voltage necessary for the backlight 6 based on the control signal from a monitoring circuit 8 that will be specifically described herein below.

The liquid crystal display device is further provided with a monitoring circuit 8 for monitoring the observed value consisting of at least either of the value of electric current or the value of voltage existed in the power source line between the power source circuit 3 and the liquid crystal driver 4 and the electric source line between the power source circuit 3 and the image processing circuit 5. The data of at least one of the value of electric current or the value of voltage that reacts to an abnormal operation in the image processing circuit 5 is supplied from the image processing circuit 5 to this monitoring circuit 8. As examples of the value of electric current or the value of voltage that reacts to the abnormal operation, the average value of voltage, maximum value of voltage, minimum value of voltage, and the value of electric current applied to a picture element electrode or a counter electrode may be cited. The monitoring circuit 8 constantly monitors this data to determine the occurrence of any change between this data and the data existing during the normal operation and, on detecting this change, judges it as an abnormality and controls the backlight driver 7. Otherwise, the monitoring circuit 8 controls the backlight driver 7 based on the control signal emitted from the image processing circuit 5 and directed to controlling the brightness of the backlight 6.

First, the operation during normal function of the liquid crystal device configured as described above will be explained below. In the display system of the liquid crystal display device, the prescribed electric current and voltage emanating from the power source circuit 3 are supplied via the power source line to the liquid crystal driver 4 and the image processing circuit 5 that jointly constitute the image processor 2 and, at the same time, the image processing circuit 5, on receiving the image signal and the control signal from the outside, controls the liquid crystal driver 4 and drives the liquid crystal panel 1. The monitoring circuit 8 monitors the data of at least either of the value of electric current or the value of voltage occurring in the power source line between the power source circuit 3 and the liquid crystal driver 4 and the power source line between the power source circuit 3 and the image processing circuit 5 and, when the value of electric current or the value of voltage falls within the prescribed range, regards that the display system operates normally and does not output the trouble detecting signal. At this time, the backlight driver 7 receives electric power supplied from the outside and causes the backlight 6 to emit light of prescribed brightness. On that occasion, when the control signal supplied to the image processing circuit 5 contains brightness controlling information tending to control the brightness of the backlight 6 or when the image processing circuit 5 happens to be forming a control signal for controlling the brightness of the backlight 6 for the purpose of enabling an image to be displayed with the optimum quality as synchronized with the display signal supplied to the liquid crystal driver 4, this image processing circuit 5 supplies the monitoring circuit 8 with a control signal for controlling the brightness (light emission) of the backlight 6. By receiving the control signal from the image processing circuit 5 thereby causing the monitoring circuit 8 to control the backlight driver 7 and maintain the prescribed brightness or by controlling the brightness as synchronized with the displayed image, it is made possible to attain control of the brightness of the backlight 6.

Second, the operation that ensues when a trouble occurs in the liquid crystal display device will be explained below. When an abnormality occurs in any of the liquid crystal panel 1, the liquid crystal driver 4, and the image processing circuit 5 and the image display on the liquid crystal panel 1 is consequently stopped, the value of electric current decreases in the power source line serving to supply electric power from the power source circuit 3 to the image processor 2 and, at the same time, a change of the voltage occurs in most cases. When the circuit system generates a short circuit and brings the display to a stopped state, the value of electric current in the aforementioned power source line is increased and the voltage is similarly varied. This invention, therefore, detects a trouble by serving the fluctuation of at least either of the value of electric current or the value of voltage as an index of the trouble in the display system.

To be specific, the monitoring circuit 8 monitors at least either of the value of electric current and the value of voltage in the electric source line between the power source circuit 3 and the liquid crystal driver 4 and in the electric source line between the power source circuit 3 and the image processing circuit 5 and, when the value of electric current and the value of voltage deviate from the prescribed ranges, outputs to the backlight driver 7 a trouble detection signal indicating that an abnormality has occurred in the display system, namely that a trouble has been detected. The subject of the monitoring fulfilled by the monitoring circuit 8 may be both or either of the electric source line between the power source circuit 3 and the liquid crystal driver 4 and the electric source line between the power source circuit 3 and the image processing circuit 5. The backlight driver, on receiving a trouble detection signal from the monitoring circuit 8, works such a control as varies the light-emitting condition of the backlight 6 and induces a change in the brightness or the color of the screen of the liquid crystal display device. The expression “control to change the light-emitting condition” refers, for example, to causing the backlight 6 to vary its brightness to the maximum or minimum level, induce a flushing operation, or, when the backlight 6 happens to be a LED light source, exercising such a control as to vary its chromaticity. As a result, the viewers are able to know that a trouble has occurred in the liquid crystal display device. The expression “the brightness of the backlight 6 is varied” as used herein includes continuously or gradually changing the brightness of the backlight 6 over time and flickering the backlight 6.

The foregoing explanation describes that directly monitoring of the change in electric current or voltage occurring between the liquid crystal driver 4 and the image processing circuit 5, and between the same driver 4 and the power source circuit 3. In the case of such a trouble as ceasing supply of an image signal or a control signal to the image processing circuit 5 and shunning renewal of an image on the screen, it is conceivable that the monitoring solely of the power source system for the power source circuit 3 and the image processor 2 will not fully detect an abnormality. In such a case, the backlight driver 7 may be controlled by the similar way of controlling the monitoring circuit 8 with a detection signal received from an abnormality detecting circuit (not shown) disposed in the image processing circuit 5.

By utilizing the backlight 6 that is driven by a separate driver from the liquid crystal panel 1 as described above, it is possible to notify the result of trouble detection in the display system as a change in brightness and chromaticity of the image plane of the liquid crystal display device, and certainly to warn the viewers about the trouble of the liquid crystal device. Further, since the change in brightness and chromaticity of the screen on the display induced by the backlight 6 is noticeable, the viewers are easily alarmed about the trouble has occurred in the liquid crystal display device.

Though the mode of embodiment described above has illustrated the liquid crystal display device wherein the image processor 2 includes both the liquid crystal driver 4 and the image processing circuit 5, it could be that the image processor 2 only includes the liquid crystal driver 4 excluding the image processing circuit 5 or vice versa. Under the above-mentioned liquid crystal display device, the effect of this invention can be achieved by monitoring with the monitoring circuit 8 only the electric source line between the power source circuit 3 and the liquid crystal driver 4 or the image processing circuit 5.

The liquid crystal display device of this invention does not need to be limited to the configuration described heretofore but may allow various alterations so long as the detection of a trouble is accomplished by monitoring at least the power source line between the power source circuit and the image processor and the change of such light-emitting conditions as brightness and chromaticity of the backlight is accomplished by the backlight driver. Further, this invention can be applied not only to the method of backlight but also to the method of front light.

While the mode of embodiment described above has cited, for example, the liquid crystal display device using a liquid crystal panel in the display, it goes without saying that this mode is similarly applicable to the display device of the non-self-luminous that needs an illuminating light from a light source to display an image on the screen.

What is claimed is:

1. A display device provided with
a non-self-luminous display;
an image processor for driving said display based on an image signal and a control signal entered from the outside;
a power source circuit for supplying an electric power to said image processor;
a light source for irradiating said display with light;
a light source driver for supplying an electric power to said light source and controlling the brightness of said light source; and
a monitoring circuit for monitoring the observed value consisting of at least either the value of electric current or the value of voltage of a power source line intervening between said power source circuit and said image processor, and characterized by
said monitoring circuit outputting to said light source driver a trouble detection signal indicating occurrence of a trouble when said observed value deviates from a given range and
said light source driver admitting said trouble detection signal and varying the light-emitting condition of said light source.

2. A display device according to claim 1, wherein
said image processor is provided with at least either of a driver for driving said display or an image processing circuit for controlling said driver and
said monitoring circuit is adapted to monitor the observed value of an electric source line intervening between at least either of said driver or said image processing circuit and said power source circuit.

3. A display device according to claim 2, wherein said monitoring circuit is controlled based on the data issuing from said image processing circuit.

4. A display device according to any of claims 1 to 3, wherein said display is a liquid crystal display panel.
